(19) United States
(12) Patent Application Publication
(10) Pub. No.: US 2009/0000429 A1
(43) Pub. Date: Jan. 1, 2009

(54) Sheet stock and pipe handling tool

(76) Inventor: W. Wayne Spatig, New Albany, IN (US)

Correspondence Address: David W. Carrithers;CARRITHERS LAW OFFICE, PLLC, Suite 206, 6200 Dutchman's Lane, Louisville, KY, 40205, US

(21) Appl. No.: 12/082,680

(22) Filed: Apr. 11, 2008

Related U.S. Application Data
(60) Provisional application No. 60/922,791, filed on Apr. 11, 2007.

(51) Int. Cl. B25B 13/28

(52) U.S. Cl. 81/90.1

(57) ABSTRACT

A pipe and sheet stock handling tool disclosed herein comprises a handle with a forked gripping means at the end which can be placed astraddle one edge of the sheet of metal or the edge of the pipe. Lifting the handle causes the tool to grip said sheet stock and allow simple movement and/or positioning. The fork has gripping teeth (perhaps comprising a biting screw pointed on the end and adjustable and lockable for varying stock thickness) on each jaw that will grab or bite into the stock to provide a stable grip. A variation of the tool (a multi fork version) has one fork on a first end of the handle and 2 forks (one fork attached to the outer jaw of the other) on a second end. The fork on the first end is similar to the one mentioned above. The forks on the second end comprise a larger simple fork with yet another fork attached with a screw on the outer jaw and an opposing smoothly curved inner jaw specially designed for soft metal (such as copper) which may need to be handled without marring.

This application claims priority from Provisional Application Ser. No. 60/922,791 filed on Apr. 11, 2007 which is incorporated herein in its entirety.

### TECHNICAL FIELD

The present invention is generally related to a field associated with the handling of sheet stock (primarily comprised of metal but not exclusively so) and lengths of pipe (of various compositions).

### BACKGROUND OF THE INVENTION

In industrial or commercial settings, sheet stock is generally delivered to the worksite in stacks. The sheet is generally heavy with possibly sharp edges and cumbersome to manipulate. A tool is needed that makes it easier and safer to move one or at most, a few pieces of said stock into position for it to be used for whatever purpose necessary. Likewise, lengths of pipe are often difficult and unsafe to handle due to weight, sharp edges, etc. Again, a tool is needed to facilitate safer and easier manual transport or manipulation of said pipe.

Tools have been proposed that engage and manipulate barrels, buckets and lumber. Reference may be taken to U.S. Pat. No. 5,695,230 to Thompson, Dec. 9, 1997, a panel handle; to U.S. Pat. No. 4,762,303 to Thomas, Aug. 9, 1988, a lumber turning tool; to U.S. Pat. No. 6,048,009 to Sorg, Apr. 11, 2000, a “drum handling tool”; to U.S. Pat. No. 163,659 to Hoyt, May 25, 1875 for a tool to handle wood stove implements; and to U.S. Pat. No. 1,367,063 to Logan, Feb. 1, 1921, a barrel tipper. Thompson's panel handle has screws whose points are to be forcibly turned into the wooden panel, thus locking the handle onto the panel allowing transport, after which, the screws must then be withdrawn from the panel with a screw driver or some other tool when finished. The other four tools cited teach a leveraged action to move or tip, but they are not able to carry, push or pull a heavy load as is described in the present invention.

### SUMMARY OF THE INVENTION

The present invention includes a handle with an approximately ‘c’ shaped fork attached on one or both ends. The jaws of the fork are fitted with adjustable ‘gripping’ screws that set the throat width and thus determine the thickness of the stock or pipe which can be manipulated with said tool. Knurled nuts are fitted to allow the screw adjustment to be ‘locked’ so that during use, the adjustment is not lost. The screws, once set, need not be readjusted until the user needs to handle a different stock thickness. The angle subtended by the ‘jaws’ of the fork and the handle can be from 90° to 180° but should preferably be 120° to 160° to facilitate gripping of the stock by the tool when the stock is captured in the throat between the screws and the handle is lifted. As stated above, sheet stock or pipes can be heavy and have sharp edges. Sliding, shifting and carrying said stock or piping can be very difficult and could cause repetitive task injury and physical stress. Using said tool, one in each hand when necessary, can greatly facilitate and ease such tasks. An object of the present invention is to provide a tool which eases the handling of sheet stock and piping and prevents possible back and hand injury. Another object of the invention is to provide a tool which can be used to push, pull, carry, or otherwise maneuver said stock or piping.

### BRIEF DESCRIPTION OF THE DRAWINGS

A better understanding of the present invention will be had upon reference to the following description in conjunction with the accompanying figures in which like numerals refer to like parts throughout the views and wherein:

FIG. 1 is an oblique view of a simple pipe and sheet stock handling tool provided in accordance with the present invention;

FIG. 2 is a side view of the pipe and sheet stock handling tool;

FIG. 3 is an oblique partial view of the multi tool;

FIG. 4 is a side partial view of the multi tool showing the arcuate surface on the upper jaw;

FIG. 5 is a bottom partial view of the multi tool showing the arcuate surface on the upper jaw;

FIG. 6 is a side view of the multi tool with a single set of gripping jaws on a first end and a dual set of gripping jaws on a second end;

FIG. 7 is an oblique partial view of the multi tool wherein the outer jaw gripping means has a knurled surface;

FIG. 8 is an oblique partial view of the multi tool wherein the outer jaw gripping means has a nonmarring rubberized surface

FIG. 9 is an oblique view of a simple pipe and sheet stock handling tool provided in accordance with the present invention;

FIG. 10 is a side view of the pipe and sheet stock handling tool shown in FIG. 9;

FIG. 11 is a bottom view of the pipe and sheet stock handling tool shown in FIG. 9;

FIG. 12 is a top view of the pipe and sheet stock handling tool shown in FIG. 9;

FIG. 13 is a left end view of the pipe and sheet stock handling tool shown in FIG. 9;

FIG. 14 is a right end view of the pipe and sheet stock handling tool shown in FIG. 9;

FIG. 15 is an oblique view of the multi tool with a single set of gripping jaws on a first end and a dual set of gripping jaws on a second end;

FIG. 16 is a side view of the multi tool shown in FIG. 15;

FIG. 17 is a top view of the multi tool shown in FIG. 15;

FIG. 18 is a bottom view of the multi tool shown in FIG. 15;

FIG. 19 is a left end view of the multi tool shown in FIG. 15;

FIG. 20 is a right end view of the multi tool shown in FIG. 15;

FIG. 21 is a close up view of the rubberized surface feature in FIG. 8; and

FIG. 22 is a close up view of the knurled surface feature in FIG. 7.

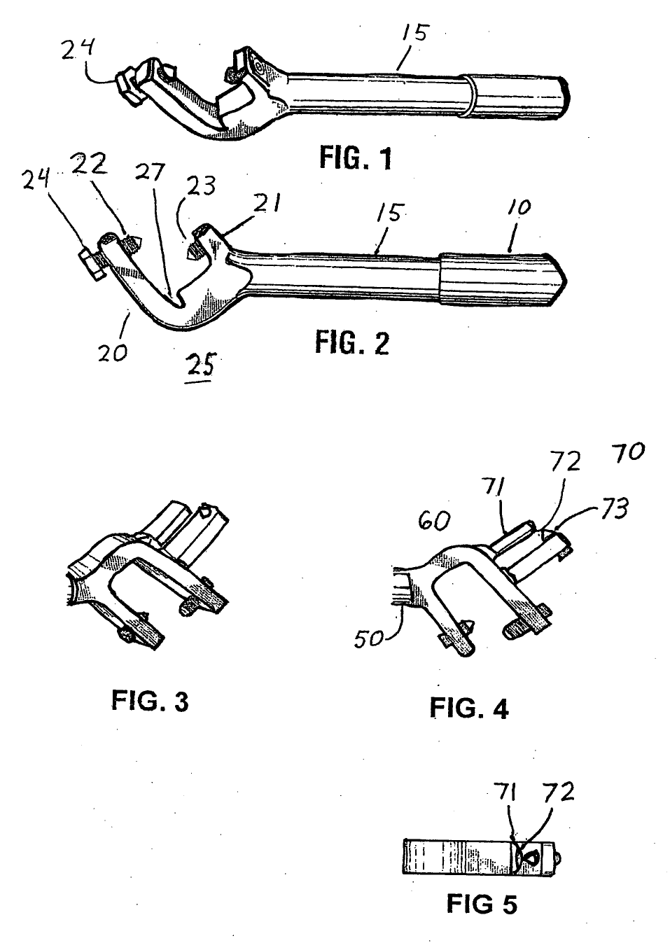

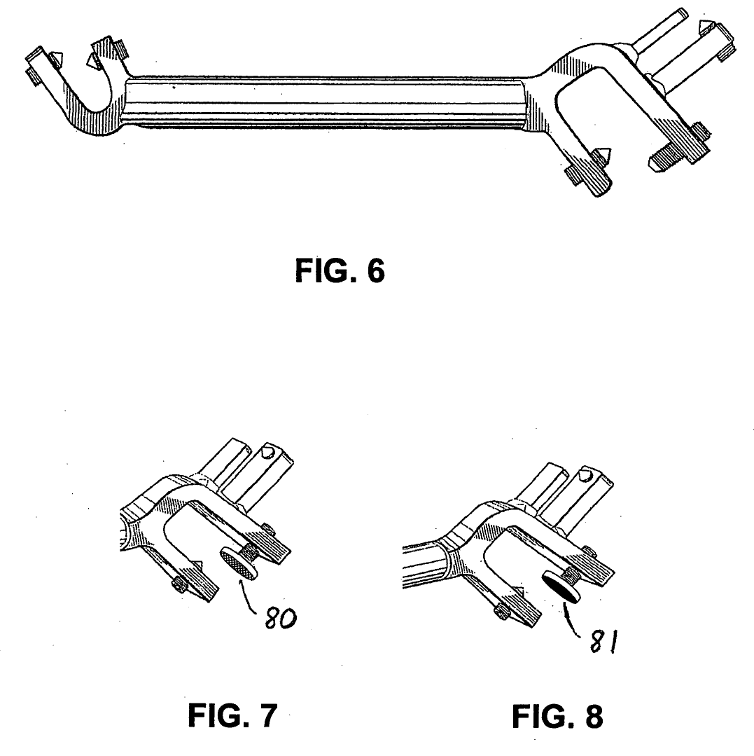

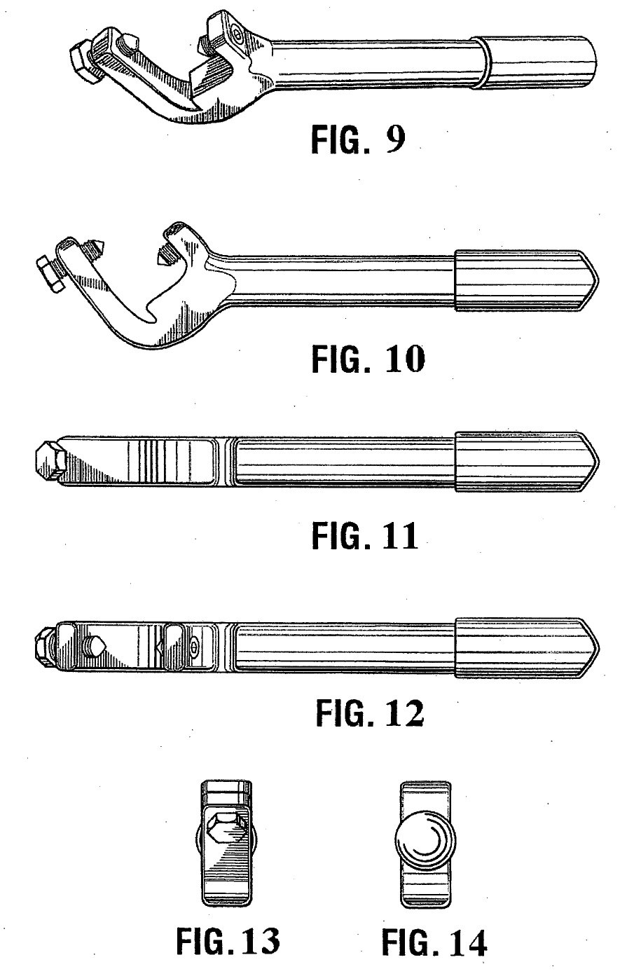

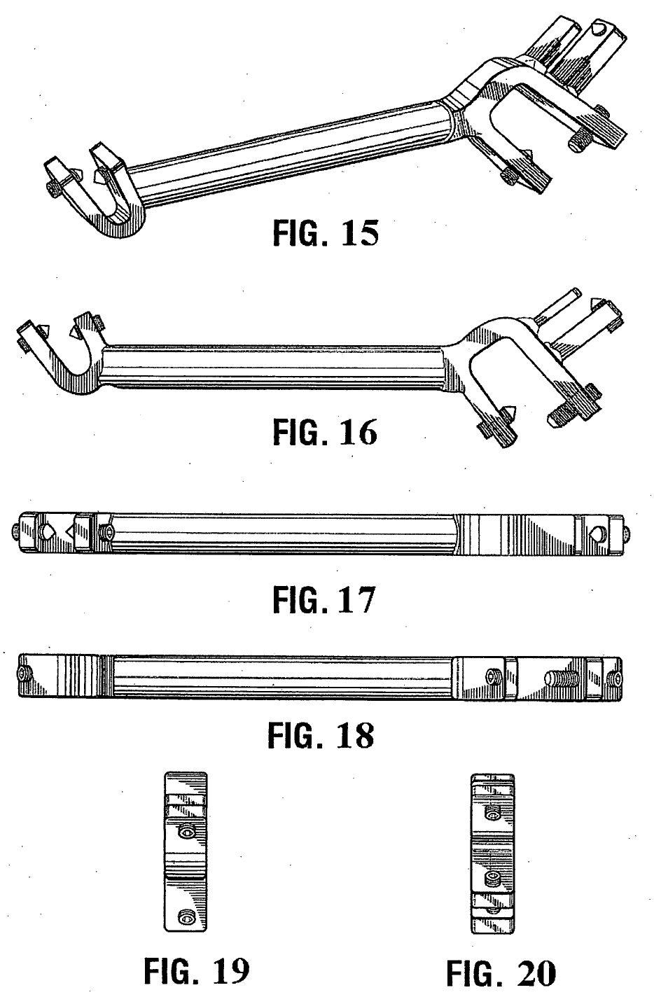

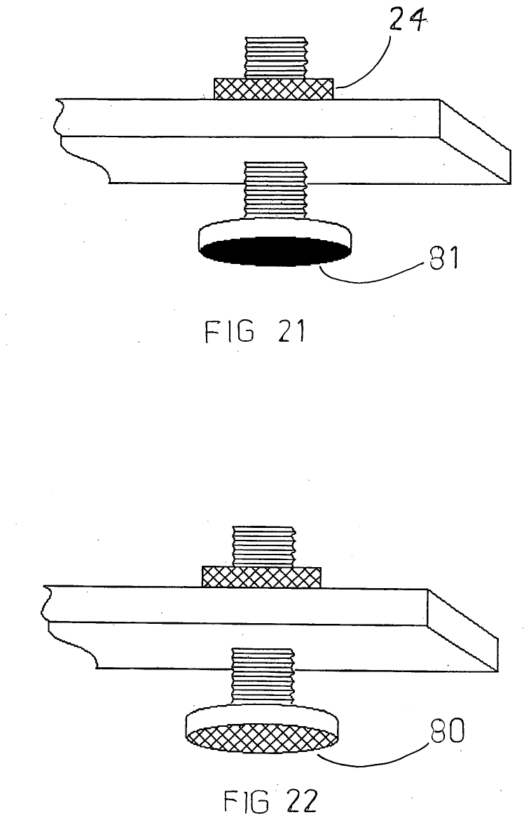

### DESCRIPTION OF THE PREFERRED EMBODIMENTS

Illustrated in the drawings, FIG. 2 is a tool comprised of a handle 15 with ‘C’ shaped gripping fork 25 at one end used to move sheet stock or lengths of pipe. The handle 15 subtends an angle of 30° to 60° with the ‘C’ shaped gripping jaws 20 and 21 providing leverage to both grip the stock and create a comfortable handle for lifting said stock. Gripping screws 22, 23 are pointed to firmly engage the stock. Said screws are each adjustable to set the material thickness. The screws are fitted with a knurled locking nut 24 to lock the said adjustment so that the setting will not be lost as the tool is used. The handle is fitted with a rubber cover 10 for improved ergonomics. The cover may enclose the entire shaft 15 and be shaped for comfort and improved grip. A notch 27 provides gripping means (in combination with screw 22) for use on thin stock.

An alternate embodiment is illustrated in FIG. 4. The handle 50 with two sets of gripping jaws 60 and 70 on the upper end. These may all be set to differing material thicknesses to cut down on necessary adjusting. Gripping screw 73 is in opposition with gripping jaw 71 which is provided with an arcuate surface 72 for stock contact with no gripping screw. This curved surface 72 (shown in FIG. 5 also) is for handling soft stock such as copper or rigid plastic and prevents marring of the surface of said stock. This curved surface 72 may be coated with rubber or some similar substance to improve handling characteristics.

Other embodiments comprise contrasting gripping means which may have a flattened knurled end 80 instead of a point, or may have an end with a rubberized surface 81.

The gripping screws of all embodiments before mentioned are interchangeable due to the fact that they may be removed and simply threaded into any existing jaws.

For ease of manufacturing, a simpler tool may have unadjustably attached gripping teeth (welded, staked or otherwise attached) instead of screws.

The foregoing detailed description is given primarily for clearness of understanding and no unnecessary limitations are to be understood therefrom, for modifications will become obvious to those skilled in the art based upon more recent disclosures and may be made without departing from the spirit of the invention and scope of the appended claims.

I claim:

1. A pipe and sheet stock handling tool comprising:
a substantially straight handle;
a gripping means disposed at a first end of said handle comprising a C-shaped fork having two jaws roughly parallel to one another with the outer jaw longer than the inner jaw;
said outer jaw and said handle subtending an angle between 90° and 180°;
said jaws being fitted with inwardly pointing gripping screws threaded into said jaws and pointed at the ends for biting or gripping said pipe or sheet stock;
said screws located near the end of each jaw with the axes of said screws noncollinear but approximately parallel to one another; and
said screws having a knurled nut threaded onto the end opposite the pointed end for locking said screw.

2. The pipe and sheet stock handling tool of claim 1 wherein said gripping screws are terminated at the contact end with a nonmarring knurled surface perpendicular to said screws.

3. The pipe and sheet stock handling tool of claim 1 wherein said gripping screws are terminated at the contact end with a nonmarring rubberized surface perpendicular to said screws.

4. The pipe and sheet stock handling tool of claim 1 wherein said outer jaw and said handle subtend an angle between 120° and 150°.

5. The pipe and sheet stock handling tool of claim 1 wherein said straight handle is fitted with a rubber or plastic grip.

6. A pipe and sheet stock handling tool comprising:
a substantially straight handle;
a gripping means disposed at a first end of said handle comprising a C-shaped fork having two jaws roughly parallel to one another with the outer jaw longer than the inner jaw;
said outer jaw and said handle subtending an angle between 90° and 180°;
said outer jaw being fitted with an inwardly pointing gripping screw threaded into said jaws and pointed at the end for biting or gripping said pipe or sheet stock;
said screw having a knurled nut threaded onto the end opposite of the pointed end for locking said screw; and
said inner jaw having a nonmarring arcuate stock-contacting surface.

7. The pipe and sheet stock handling tool of claim 6 wherein said gripping screw is terminated at the contact end with a nonmarring knurled surface perpendicular to said screw.

8. The pipe and sheet stock handling tool of claim 6 wherein said gripping screw are terminated at the contact end with a nonmarring rubberized surface perpendicular to said screw.

9. The pipe and sheet stock handling tool of claim 1 wherein said outer jaw and said handle subtend an angle between 120° and 150°.

10. The pipe and sheet stock handling tool of claim 6 wherein said straight handle is fitted with a rubber or plastic grip.

11. The pipe and sheet stock handling tool of claim 1 wherein a second gripping means is disposed at a second end of said handle comprising a C-shaped fork having two jaws roughly parallel to one another with the outer jaw longer than the inner jaw;
said outer jaw and said handle subtending an angle between 90° and 180°;
said outer jaw being fitted with an inwardly pointing tooth for biting or gripping said pipe or sheet stock; and
said inner jaw having a nonmarring arcuate stock contacting surface

12. The pipe and sheet stock handling tool of claim 11 wherein said gripping screws are terminated at the contact end with a nonmarring knurled surface perpendicular to said screws.

13. The pipe and sheet stock handling tool of claim 11 wherein said gripping screws are terminated at the contact end with a nonmarring rubberized surface perpendicular to said screws.

14. The pipe and sheet stock handling tool of claim 11 wherein said outer jaw and said handle subtend an angle between 120° and 150°.

15. The pipe and sheet stock handling tool of claim 11 wherein said straight handle is fitted with a rubber or plastic grip.
